(19) United States
(12) Patent Application Publication
(10) Pub. No.: US 2025/0210899 A1
(43) Pub. Date: Jun. 26, 2025

(54) CAGE FOR THE RECEPTION OF A CONTACT ELEMENT

(71) Applicant: Rosenberger Hochfrequenztechnik GmbH & Co. KG, Fridolfing (DE)

(72) Inventors: Robin HAEFFNER, Fridolfing (DE); Waldemar WINTERHOLLER, Fridolfing (DE); Matthias SALEMINK, Fridolfing (DE)

(21) Appl. No.: 18/975,164

(22) Filed: Dec. 10, 2024

(30) Foreign Application Priority Data
Dec. 20, 2023 (EP) 23 218 414.3

(51) Int. Cl. H01R 13/18

(52) U.S. Cl. CPC H01R 13/18

(57) ABSTRACT

A cage for the reception of a contact element for an electric plug connector has a fixing region for fixing the cage on the contact element, and a spring region, axially adjoining the fixing region, for contacting a contact spring arm of the contact element with a spring force. The cage has a covering region, axially adjoining the spring region, for covering a plug-in end of the contact element. An aperture is formed in the spring region, in which is arranged a rib with the first axial end connected to the fixing region and the second axial end connected to the covering region. Starting from the first and second axial ends, the rib is twisted through a torsion angle relative to a longitudinal axis of the rib in such a way that the contact spring arm is contactable by a contact point of the rib with the spring force.

### CROSS-REFERENCE TO RELATED APPLICATION

This application claims the benefit and priority of European Patent App. Ser. No. 23 218 414.3 filed on Dec. 20, 2023, the entire disclosure of which is incorporated herein by reference.

### FIELD OF THE INVENTION

The present invention relates to a cage for the reception of a contact element.

The present invention furthermore relates to a contacting device having a contact element and a cage, through which the contact element at least partly extends.

Finally, the present invention relates to an electric plug connector having a contacting device and a plug connector housing, through which the contacting device at least partly extends and to which the contacting device is connected.

### TECHNICAL BACKGROUND

Electric plug connectors, in particular electric plug connectors for high-voltage applications, e.g. in electric or hybrid vehicles, have contact elements made of a material with a high electrical conductivity. In high-voltage applications, copper is preferably used for this purpose. However, as is known, copper has the disadvantage of low resistance to ageing and low temperature stability. The elasticity or spring force of contact spring tabs or of contact spring arms of a contact element which contact an associated mating contact element decreases on account of material fatigue (relaxation) in the course of time or at high temperatures of the kind that typically occur in high-voltage plug connectors. In both cases, the electric contact resistance between the contact element and the mating contact element gets worse in a disadvantageous way and, in extreme cases, may end in loss of contact.

To prevent this, EP 2 690 716 B1, for example, proposes to fit the contact element into a sleeve-shaped housing—also referred to as a cage—at least in its contacting region, in which housing a number of oversprings corresponding to the number of contact spring arms of the contact element is formed. If the housing, with its oversprings, is produced from a material with a lower material fatigue, comprising stainless steel for example, and if each contact spring arm of the contact element is contacted by an associated overspring of the housing, then, if there is material fatigue of the copper in the contact element, the constant spring force of the overspring acts on the associated contact spring arm and prevents a deterioration in the electrical contact between the contact spring arm and the mating contact element.

A contacting device of this kind comprising a contact element and a cage has essentially the following technical disadvantages:

Owing to a relative movement between the individual contact spring arms and the associated oversprings during the process of plugging in the contacting device with the mating contact element, friction arises between the individual contact spring arms and the associated oversprings, and this additionally increases the plug-in force.

Moreover, the oversprings, which are attached to the cage on one side, are more susceptible to damage, e.g. bending, while being handled during assembly.

It is the aim to mitigate both technical disadvantages.

### SUMMARY OF THE INVENTION

Given this background, it is the underlying object of the present invention to specify a contacting device comprising a contact element and a cage which is improved in respect of its mechanical and/or geometrical properties.

According to the invention, this object is achieved by a cage having the features of Patent claim 1.

Accordingly, the following are provided:

A cage for the reception of a contact element, having
a fixing region for fixing the cage on the contact element,
a spring region, axially adjoining the fixing region, for contacting a contact spring arm of the contact element with a spring force, and
a covering region, axially adjoining the spring region, for covering a plug-in end of the contact element,
wherein an aperture is formed in the spring region,
in which aperture there is arranged a rib,
the first axial end of which is connected to the fixing region and
the second axial end of which is connected to the covering region,
wherein, starting from the first axial end and from the second axial end, the rib is in each case twisted through a torsion angle relative to a longitudinal axis of the rib in such a way that the contact spring arm is contactable by a contact point of the rib with the spring force.

The insight/concept underlying the present invention consists in providing a cage having at least one rib, which is attached at each of its two axial ends to the cage and, starting from its two axial ends, is twisted about its longitudinal axis in such a way that, on the one hand, the rib of the cage contacts an associated contact spring arm of the contact element and, on the other hand, the twisting of the rib results in a spring force in the rib which acts in rotation with respect to the longitudinal axis and exerts a contact force on the associated contact spring arm.

The attachment of the two axial ends of the rib to the cage allows only a rotary motion of the rib about its longitudinal axis during the process of plugging the mating contact element into the contact element. In contrast, the associated contact spring arm of the contact element, which is attached to the contact element at a single axial end, leads during the plug-in process to a rotary motion about an axis which is orthogonal with respect to the longitudinal axis of the contact element and thus to the longitudinal axis of the cage and which runs in the transition between the contact spring arm and the remaining body of the contact element. Because the rib is attached to the cage on both sides, it does not carry out such a rotary motion about an axis that is orthogonal with respect to the longitudinal axis of the cage. The relative movement between a rib rotating about its longitudinal axis and a contact spring arm rotating about an axis that is orthogonal thereto is significantly smaller than a relative movement between an overspring and a contact spring arm according to the prior art, which both rotate about an associated and mutually parallel axis. Thus, the friction, associated with a relative movement, between the rib of the cage according to the invention and the associated contact spring arm is significantly reduced and thus advantageously allows a significantly lower plug-in force during the plug-in process.

The bilateral attachment of the rib to the cage according to the invention ensures better integration of the rib into the installation space of the cage. Protrusion of the rib from the installation space of the cage, as in the case of the free axial end of an overspring attached on one side to the cage, and hence the risk of damage to the rib during the assembly process is thus advantageously significantly reduced or completely eliminated.

A cage or a cage element can form a housing in which the contact element can be at least partly inserted. Thus, a cage is preferably of sleeve-shaped design in order to at least partly surround the contact element. The advantageous technical functions of the cage are, in particular:
to impose on the contact spring arms of the contact element an additional long-term and temperature-stable spring force in order to compensate for a declining spring force of the contact spring arms due to material fatigue,
to protect the contact spring arms of the contact element as far as possible from damage, in particular during the assembly process, and
to implement fastening of the contact element in a plug connector housing and thus axial positioning of the contact element in the plug connector housing.

The contact element thus preferably extends within the cage at least with its contacting region. The basic geometry of the cage is preferably matched to the basic geometry of the contacting region of the contact element: since the contacting region of the contact element has at least one contact spring arm, which is in each case of elongate shape in order to generate a sufficient spring force, not only the contact element but also the cage are elongate in shape. If the contact element is designed as a rotationally symmetrical round contact with a plurality of contact spring arms arranged in a rotationally symmetrical configuration with respect to the longitudinal axis, the associated cage is also made rotationally symmetrical with respect to its longitudinal axis. If the contact spring arms of the contact element for contacting a flat mating contact element are arranged in a cuboidal basic structure with a rectangular cross-sectional profile, the cage also has a cuboidal basic structure with a rectangular cross-sectional profile.

Since the contact element and the associated mating contact element can preferably be plugged in in the direction of the longitudinal axis with respect to one another, the cage preferably has a plug-in opening at the end for the insertion of the mating contact element. Since preferably only one portion of the length of the contact element extends in the cage, a remaining body of the contact element, preferably the connecting region, which is designed as a crimping region for example, is extended out of the cage. A respective end opening is therefore preferably formed in the cage at its two axial ends. Consequently, the cage preferably has a sleeve-shaped geometry which preferably surrounds the contact element at least in the contacting region. As explained in detail below, the mating contact element can also be suitable for lateral insertion into the contacting region of the contact element. Respective lateral plug-in openings for feeding in the mating contact element can thus be formed in a portion of the length on at least one side of the cage in which at least the contacting region of the contact element is arranged within the cage.

The cage is preferably produced from a material with low material fatigue, which preferably comprises stainless steel. The cage is preferably produced by stamping and bending. However, production of the cage by metal removal or casting is also conceivable.

In the cage of elongate shape, a fixing region is formed in such a way that the fixing region can be connected in a mechanically stable manner to an associated fastening region of the contact element. For this purpose, the geometry of the fixing region of the cage preferably corresponds to the geometry of the fastening region of the contact element: a fastening region, e.g. a sleeve-shaped fastening region, of the contact element with a rectangular cross-sectional profile can extend in a likewise sleeve-shaped fixing region of the cage with a likewise rectangular cross-sectional profile. However, deviations from such equality of geometry are also conceivable as long as mechanically stable fixing is thereby possible: a fastening region of the contact element with a U-shaped cross-sectional profile can extend in a fixing region of the cage with a rectangular cross-sectional profile, for example.

The fixing between the fixing region and the fastening region is preferably of positive design. For example, at least one latching tab, in each case punched out and bent over in the fixing region, is in each case latched in an associated latching recess formed in the fastening region. In a less preferred embodiment, positive engagement between the fixing region and the fastening region can also be implemented by means of an additional body, e.g. a clip, which is latched in associated latching recesses of the fixing region and of the fastening region. In addition, nonpositive fixing between the cage and the contact element is also conceivable, where, for example, a press fit is implemented between the fixing region and the fastening region. Finally, materially bonded connection between the cage and the contact element can also be implemented, e.g. by means of one or more brazing or welding points between the fixing region and the fastening region.

Adjoining the fixing region of the cage axially in the direction of the plug-in end of the cage is the spring region of the cage, in which at least one rib for contacting an associated contact spring arm arranged opposite in the contact element is formed.

Adjoining the spring region of the cage axially in the direction of the plug-in end of the cage is the covering region of the cage, which is configured to cover the plug-in end of the contact element.

The three regions of the cage—the fixing region, the spring region and the covering region—are preferably connected integrally to one another, especially in the case of a cage implemented as a stamped and bent part. In a less preferred design, the three regions of the cage may also each be produced from an individual part and then connected to one another by known techniques. Thus, each individual rib of the spring region is preferably also connected in each case to the fixing region and the covering region.

Here and below, a rib should be understood to mean a preferably elongate formation with a small thickness. The longitudinal extent is thus typically a multiple of the lateral transverse extent. The small thickness and the width of the rib, which is many times less than the length, allows easy deformation of the rib in a direction of rotation with respect to the longitudinal axis of the rib. A rib of this kind, which is also referred to as a torsion rib on account of its suitability for torsion, is prestressed by the torsion and can transmit the spring force imposed by the torsional prestress as a contact pressure to the contacting contact spring arm of the contact element.

Each individual rib of the spring region is connected at one axial end, which is referred to here and below as the first axial end of the rib, to the fixing region, and at another axial end, which is referred to here and below as the second axial end of the rib, to the covering region. Thus, in each case in its direction of longitudinal extent, each individual rib extends in the direction of longitudinal extent of the cage and thus in the direction of longitudinal extent of the contact element, which is arranged at least partly in the cage. To enable a torsional movement to be carried out unhindered, each individual rib is preferably not connected to the cage at a lateral end or a lateral edge.

Thus, each individual rib is arranged in an aperture of the cage, i.e. in a passage through the cage. In this case, a respective associated aperture can be formed in the cage for each individual rib. Alternatively, a plurality of adjacent ribs can be arranged in a common aperture. The ribs, which are each formed on a side wall of a cuboidal cage, can be arranged in a common aperture of the cage, for example.

Each individual rib makes point contact with the associated contact spring arm of the contact element by means of a contact point situated on the surface of the rib.

The contact point is preferably situated on an edge of the rib which is closest to the associated contact spring arm or which is formed on the rib in the direction of the contact spring arm. The contact point is situated between the first and the second end of the rib, preferably in the axial center between the first and the second end of the rib. Alternatively, as explained in greater detail below, the contact point of the rib can also be axially offset with respect to the axial center of the rib.

The covering region of the cage, which is designed to protect the plug-in end of the contacting region, i.e. the individual contact spring arms of the contact element, extends at least as far as the plug-in end of the contact element and preferably beyond the plug-in end of the contact element. In addition, for further protection of the contact element, an end protector for the contact element may also be provided on the covering region.

Advantageous embodiments and developments can be found in the additional dependent claims and in the description with reference to the figures of the drawing.

It is self-evident that the features mentioned above and those that will be explained below can be used not only in the respectively specified combination but also in other combinations or on their own without departing from the scope of the present invention.

In a preferred embodiment of the invention, the contact point of the rib can be formed in a lateral portion of the rib which forms a lateral extension or a lateral offset of the rib in a direction toward the associated contact spring arm. Such an extension or such an offset of the rib can also be referred to as a contact tongue. Particularly in the case of a rib of narrow design, the approach of the contact point of the rib to the associated contact spring arm brought about by the torsion of the rib may be too short to achieve contacting between the contact point of the rib and the associated contact spring arm. In the case of a narrow rib, the design of the lateral extension or lateral offset allows reliable contacting of the contact spring arm by the contact point of the rib.

In another advantageous embodiment of the invention, the single rib can have a rounded edge at the respective contact point. In this way, abrasion of a coating on the surface of the contact element can be reduced or, in the best case, prevented. Particularly in the contacting region, the contact element has a coating consisting of a material with a high electrical conductivity, preferably made of silver or gold, in order to reduce the electric contact resistance between the contact element and the mating contact element, which is important for high-voltage applications.

The torsion angle through which the individual rib is torsioned or twisted to the maximum extent, in each case relative to the longitudinal axis, in the region of the contact point can preferably be configured to be between 10° and 50°. If the torsion angle of the rib is less than 10° in this region, it is not possible to achieve a sufficient spring force in the rib to boost the spring force of the contact spring arm. If a torsion angle of 50° is exceeded, the spring force exerted by the rib on the contact spring arm is excessive, and the required plug-in force is too high. A better compromise between an achievable spring force in the rib and an occurring plug-in force can particularly preferably be achieved by a torsion angle between 18° and 30° and very particularly preferably between 21° and 24°.

As already explained, in a preferred embodiment, the cage according to the invention can accommodate a flat contact element, i.e. a flat contact element designed as a coupler for plug connection to a flat mating contact element designed as a contact blade. In this preferred embodiment, the cage can have a cuboidal basic geometry with a rectangular cross-sectional profile.

A rib can be formed on one side of the cage, said rib contacting a single contact spring arm of the contact element with a spring force in order to fix a flat mating contact element between the single contact spring arm and the opposite side wall. Alternatively, symmetrically arranged ribs can be formed on opposite sides of the cage, i.e. oppositely arranged ribs, in at least one pair of ribs. Finally, it would be conceivable to form ribs asymmetrically on two opposite sides of the cage, e.g. one rib on one side and, with a lateral offset relative to the latter, two ribs on the opposite side of the cage.

If the flat contact element has two pairs of contact spring arms in its contacting region, each consisting of contact spring arms extending opposite one another, double abrasion of the coating on the mating contact element occurs in each lateral plug-in cycle of the flat mating contact element into the flat coupler contact element in the case of contact spring arms of identical design on account of the contact spring arms being arranged in series in the lateral direction. In order to prevent this double abrasion, the contact points of the two contact spring arms with the mating contact element in a contacting plane can each be formed with an axial offset with respect to one another in a direction of longitudinal extent of the contact spring arms.

To ensure that, as explained in more detail below, the contact point of the rib preferentially contacts a contact surface of the contact spring arm which is oriented parallel to the contacting plane of the contact spring arm with the mating contact element in the plugged state of the contact element and of the mating contact element, the axial position of the contact point of the rib with the associated contact spring arm should be aligned with the axial position of the contact point of the contact spring arm with the mating contact element: thus, in another preferred embodiment of the cage according to the invention, the contact points of those ribs that are formed on the same side of the spring region of the cage can each be formed in a manner offset with respect to one another in an axial direction of the ribs.

In particular, the contact point of a rib which contacts an associated contact spring arm, the contact point of which with the mating contact element is formed axially closer to the fastening region of the contact element, can likewise be formed axially closer to the fixing region of the cage than the contact point of another rib which contacts another associated contact spring arm, the contact point of which with the mating contact element is formed axially further away from the fastening region of the contact element.

In another particularly advantageous embodiment of the invention, it is possible in the case of ribs with contact points that are in each case formed in an axially offset manner for each of the diagonally opposite ribs of two parallel contact spring pairs to be formed at the same axial position in the longitudinal extent of the ribs. Thus, the contact points of the diagonally opposite ribs can be at the same axial distance from the fixing region.

In this way, it is advantageously possible to plug a flat contact element with two pairs of contact spring arms flexibly in the two possible orientations (i.e. orientations that are rotated through 180° relative to one another with respect to the longitudinal axis of the contact element) into the cage having ribs with contact points that are in each case formed in an axially offset manner, without providing a mutually matching mechanical coding means for this purpose on the cage and on the associated contact element respectively. The design of the ribs of the cage on one side of the cage thus corresponds to the design of the ribs of the cage on the opposite side of the cage (i.e. the view of the cage “from above” corresponds to the view of the cage “from below”).

The torsion angle of the ribs, the contact point of which is in each case axially further away from the fixing region, can preferably be greater than the torsion angle of the ribs, the contact point of which is in each case axially closer to the fixing region.

Thus, the ribs of which the associated contact point is at a greater axial distance from the fixing region can have a higher spring stiffness on the associated contact spring arm than the ribs of which the associated contact point is at a shorter axial distance from the fixing region. Since ribs, the contact point of which is in each case axially further away from the fixing region of the cage, contact a contact spring arm, the contact point of which with the mating element is axially further away from the fastening region of the contact element and thus has a lower spring stiffness, it is possible, by means of this further preferred embodiment of the invention, to make the total spring stiffness comprising the spring stiffness of the rib and the spring stiffness of the associated contact spring arm equal for all the rib-contact spring arm pairs. Thus, the mating contact element can undergo an equal contact pressure from all the contact spring arms, and hence it is possible to achieve an equal electrical contact resistance at all the electrical transitions between the contact element and the mating contact element.

Owing to the equal axial distance between the contact points of the two diagonally opposite ribs from the fixing region of the cage, the two diagonally opposite ribs are, consistent with this, each twisted by a torsion angle of the same magnitude.

In another preferred embodiment of the invention, an axial plug-in opening for axially inserting and plugging a mating contact element into the contact element can be formed at a front end of the covering region. The cross-sectional profile of the axial plug-in opening can preferably be matched to the cross-sectional profile of the mating contact element. To protect the end of the contact spring arms, the cross section of the axial plug-in opening can be reduced at the plug-in end of the cage relative to the cross section of the cage. In the case of a cage implemented as a stamped and bent part, the end covering of the contact spring arms can be achieved, for example, by bending two side walls of the covering region of the cage through 90°. As an option, the lateral end of the end covering can additionally be bent through an angle of less than 90° counter to the plug-in direction of the mating contact element in order to achieve a catch funnel function in the end covering and thus avoid a sharp edge.

In order to allow a flat mating contact element to be plugged laterally into the contact element in a plug-in direction orthogonal to the longitudinal axis of the contact element or in both plug-in directions orthogonal to the longitudinal axis of the contact element, a respective lateral plug-in opening can be formed at at least one lateral end of the spring region, preferably at both lateral ends of the spring region. The cross-sectional profile of the lateral plug-in opening can preferably be matched to the cross-sectional profile of the mating contact element. The lateral plug-in opening can extend not only within the spring region of the cage, in which the contacting region of the contact element is preferably formed, but also beyond the covering region as far as the plug-in end of the cage. In the latter case, the axial plug-in opening can merge into the at least one lateral plug-in opening. The at least one lateral plug-in opening is in each case formed on a further side of the cage, which is different in each case from the sides of the cage in which the ribs are formed.

For the lateral protection of the contact spring arms, the height of each lateral plug-in opening can be reduced relative to the corresponding lateral height of the cage at the lateral ends of the cage. In the case of a cage implemented as a stamped and bent part, the lateral covering of the contact spring arms can be achieved, for example, by bending two edge zones of the cage through 90° in the region of the lateral plug-in openings. As an option, the lateral end of the lateral coverings can in each case additionally be bent through an angle of less than 90° counter to the lateral plug-in direction of the mating contact element in order in each case to achieve a catch funnel function in the individual lateral covering and thus avoid a sharp edge.

In addition to the technical functions mentioned, the cage also performs a guiding function for the mating contact element by virtue of the formation of an end covering and of the lateral coverings.

The technical function of fastening the contact element in a plug connector housing by way of the cage can preferably be implemented by positive engagement: for this purpose, a latching means, preferably a latching hook, a latching nose or a latching tab, can be formed on the cage, and this can be latched with a mating latching means on the plug connector housing, preferably a latching recess. To achieve a high latching force, the latching means can preferably have an elongate extent in the direction of the longitudinal axis of the cage. In a particularly advantageous embodiment, the latching means is formed in an aperture of the cage in which at least one rib is also arranged. In addition to fastening of the cage on the plug connector housing by positive engagement, nonpositive fastening (e.g. press fitting) or materially bonded fastening (e.g. brazing, welding, adhesive bonding) is also conceivable.

To protect the ribs laterally from damage, respective lateral protection walls can be formed on the two lateral edges of the aperture or apertures, and, in the case of a cage implemented as a stamped and bent part, these walls can be implemented, for example, as edge zones of the aperture or apertures of the cage which are bent over laterally toward the outside.

The invention also covers a contacting device for contacting a mating contact element of an electric mating plug connector. The contacting device has a contact element and a cage, through which the contact element at least partly extends. The technical features, technical characteristics and technical aspects hitherto explained with respect to the cage apply in a similar way to the contacting device according to the invention and all other technical subjects of the invention that remain to be explained.

The contact element has at least one fastening region, which is connected or connectable to the fixing region of the cage, and a contacting region, which axially adjoins the fastening region, for electrical and mechanical contacting of an associated mating contact element. The contacting region has at least one contact spring arm, which is in each case connected to the fastening region, wherein the at least one contact spring arm is in each case configured to contact the mating contact element. As already explained further above, the contacting region can also have a multiplicity of contact spring arms. In the case of a flat contact element, there can preferably be two pairs of in each case oppositely situated contact spring arms, i.e. of in each case two contact spring arms arranged on both sides and symmetrically with respect to the flat mating contact element.

Owing to the prestressing of the rib by the twisting of the rib about its longitudinal axis, the contact point of the individual rib in each case contacts the associated contact spring arm with a spring force. The spring force from the rib acting on the associated contact spring arm leads to prestressing of the contact spring arm. In the plugged state of the contact element and of the mating contact element, the contact spring arm is additionally prestressed by the mating contact element. The contact pressure exerted on the mating contact element by the contact spring arm is thus the product of the spring force of the rib and the spring force of the associated contact spring arm. The spring force of the contact spring arm is boosted by the spring force of the rib.

Opposite the contacting region, the fastening region can be joined axially by a connecting region of the contact element for electrically and mechanically connecting the contact element to an electric conductor of an electric lead (i.e. of an electric cable) or of a circuit board. The electric connection can be made by material bonding by means of a soldered or welded joint or alternatively by positive and/or nonpositive engagement by means of a crimped connection.

In a preferred embodiment of the contacting device according to the invention, the contact point of the individual rib can contact a contact surface of the associated contact spring arm, which is shaped in such a way that, when contact is made between the contact spring arm and a contacting surface of the mating contact element, the contact surface is oriented parallel to the contacting surface. As a result, the force transmission from the rib to the contact spring arm and thus the contact pressure exerted by the contact spring arm on the mating contact element advantageously remains invariant, even if the contact point of the rib is displaced relative to the contact surface of the contact spring arm owing to variations in the accuracy of production of the cage and of its ribs.

In another preferred embodiment of the contacting device according to the invention, which is suitable especially for flat contacting, the contact element can have two pairs, each comprising two opposite contact spring arms. The contact points of the contact spring arms which are configured to contact the same contact surface of the mating contact element can be formed in a manner offset with respect to one another in an axial direction of the contact spring arms.

As already explained, this prevents double abrasion of the coating on the mating contact element in a plug-in cycle of the contact element and the mating contact element.

The contact points of the individual contact spring arms can preferably each be formed on a lateral extension or a lateral bulge of the contact spring arm in the direction of the mating contact element.

In the case of flat contacting, it is possible, in another advantageous embodiment of the contacting device according to the invention, for the contact points of the diagonally opposite contact spring arms which are configured to contact the mating contact element each to be formed at the same axial distance from the fastening region.

By this means, the relative positioning of the contact points of the individual contact spring arms of the contact element which each contact the mating contact element is matched to the relative positioning of the contact points of the individual ribs of the cage which each contact an associated contact spring arm of the contact element. The contact pressure of the individual contact spring arms of the contact element on the mating contact element, which are each subjected to an additional contact pressure by an associated rib of the cage, can thereby be set to the same level.

In addition, the invention covers an electric plug connector which has a contacting device and a plug connector housing, through which the contacting device at least partly extends and to which the contacting device is connected.

The technical features, technical characteristics and technical aspects already mentioned with reference to the contacting device apply in a similar way to the electric plug connector.

Finally, the invention also covers an electric plug connection which has an electric plug connector and an associated electric mating plug connector with a mating contact element. The mating contact element of the electric mating plug connector is electrically contactable with or electrically contacts the contact element of the contacting device integrated into the electric plug connector.

The invention also relates to a contact element, independent of claim 1, of an electric plug connector for contacting a mating contact element of an associated electric mating plug connector. This contact element has a fastening region and a contacting region, which axially adjoins the fastening region, for contacting the mating contact element, wherein the contact element has two pairs of spring contact arms, each comprising two opposite spring contact arms, which are each connected to the fastening region, wherein contact points of contact spring arms which are configured to contact the same contact surface of the mating contact element are formed in a manner offset with respect to one another in an axial direction of the contact spring arms. The dependent patent claims and the features described in the description relate to advantageous embodiments and variants of this contact element. The applicant explicitly reserves the right to claim the contact element described here independently of Patent claim 1 (that is to say preferably independently, in particular, of the “cage” and the features thereof), optionally in combination with features of the contact element described in conjunction with the cage and illustrated in the drawings together with the cage. The applicant furthermore reserves the right to claim an electric plug connector and an electric plug connection which have the contact element independent of Patent claim 1, that is to say preferably also without the cage described.

If expedient, the above embodiments and further developments can be combined in any desired manner. Further possible embodiments, further developments and implementations of the invention also include implicit combinations of features of the invention described above or below in relation to the exemplary embodiments. In particular, a person skilled in the art will also add individual aspects as improvements or supplements to the respective basic form of the present invention.

### BRIEF DESCRIPTION OF THE DRAWINGS

The present invention is explained in greater detail below with reference to the exemplary embodiments indicated in the schematic figures of the drawing. In the drawing:

FIG. 1A shows an isometric illustration of a flat contacting device according to the invention in the unplugged state,

FIG. 1B shows an isometric illustration of a flat contacting device according to the invention in the plugged state,

FIG. 2A shows a longitudinal section through a cage according to the invention for a flat contact element,

FIG. 2B shows an isometric illustration of a cage according to the invention for a flat contact element,

FIG. 2C shows a plan view of a cage according to the invention for a flat contact element,

FIG. 2D shows a cross section through a cage according to the invention for a flat contact element,

FIG. 2E shows an enlarged illustration of a detail of the cross section through a cage according to the invention for a flat contact element,

FIG. 3 shows a longitudinal section through a flat contact element according to the invention,

FIG. 4 shows a longitudinal section through a flat contacting device according to the invention,

FIG. 5 shows an isometric illustration of a plug connection according to the invention for flat contacting, said connection being plugged in at the side,

FIG. 6A shows an isometric illustration of a round contact element,

FIG. 6B shows an isometric illustration of a cage according to the invention for a round contact element,

FIG. 6C shows an isometric illustration of a round contacting device according to the invention,

FIG. 7A shows a longitudinal section through a plug connection according to the invention for front-side flat contacting in the unplugged state, and

FIG. 7B shows a longitudinal section through a plug connection according to the invention for front-side flat contacting in the plugged state.

The accompanying figures of the drawing are intended to impart greater understanding of the embodiments of the invention. They illustrate embodiments and, in conjunction with the description, serve to clarify principles and concepts of the invention. Other embodiments and many of the stated advantages will become apparent with reference to the drawings. The elements of the drawings are not necessarily true to scale with respect to one another.

In the figures of the drawing, elements, features and components that are the same, functionally the same and have the same effect are each indicated by the same reference signs, unless stated otherwise.

The figures are described below together and in an overarching way.

### DESCRIPTION OF THE EXEMPLARY EMBODIMENTS

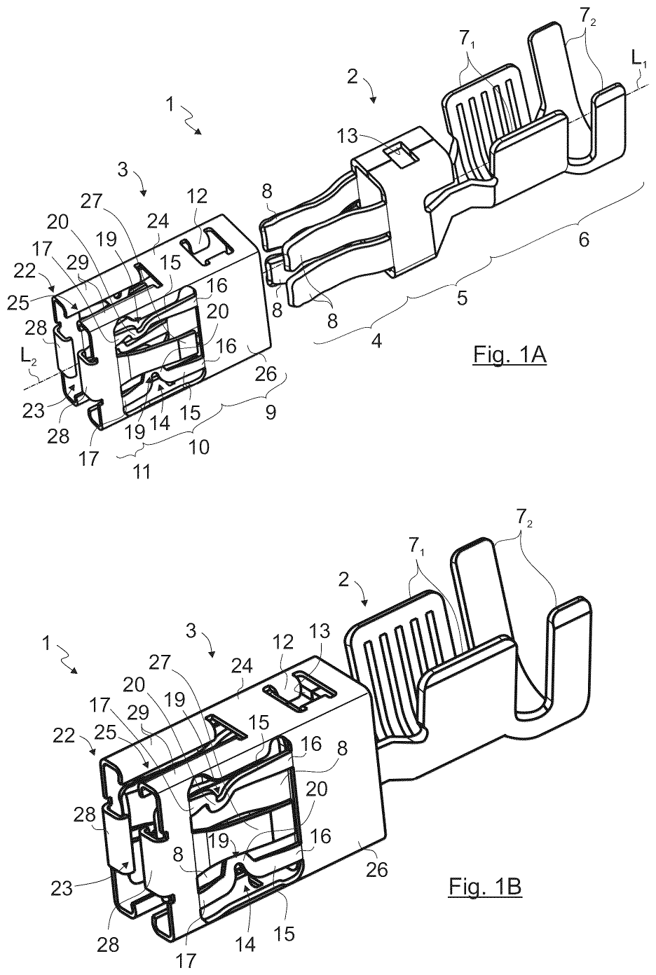

A contacting device 1 comprising a flat contact element 2 and an associated cage 3 is illustrated in the unplugged state in FIG. 1A and in the plugged state in FIG. 1B. The contact element 2 and the respective cage 3 are each produced from a stamped and bent part.

In its longitudinal extent along a longitudinal axis L₁, the contact element 2 has a contacting region 4, a fastening region 5 axially adjoining the contacting region 4, and a connecting region 6 axially adjoining the fastening region 5. In this case, the connecting region 6 is designed, for example, as a crimping region with a first crimping tab pair 7₁ for crimping to the electric conductor of a cable (not illustrated) and a second crimping tab pair 7₂ for crimping to the cable sheath of the cable. In the configuration shown in FIGS. 1A and 1B, the contacting region 4 of the contact element 2 has two pairs of contact spring arms 8, each arranged opposite one another, which are each connected at one axial end to fastening region 5. A mating contact element, which is designed as a flat contact, i.e. as a contact blade, can be inserted between the two pairs of contact spring arms 8, each arranged opposite one another, and can be contacted electrically by said arms.

In its longitudinal extent along a longitudinal axis L₂, the cage 3 has a fixing region 9, which is fixed or fixable to the fastening region 5 of the contact element 2, a spring region 10 axially adjoining the fixing region 9, and a covering region 11 axially adjoining the spring region 10.

As illustrated in FIGS. 1A and 1B, fixing between the fastening region 5 and the fixing region 8 is accomplished, for example, by means of at least one latching tab 12, which is formed on the cage 3 and is latched or latchable positively into an associated latching recess 13 formed in the contact element 2. Other positive, nonpositive or material connection variants between the fastening region 5 of the contact element 2 and the fixing region 8 of the cage 3 are possible as alternatives.

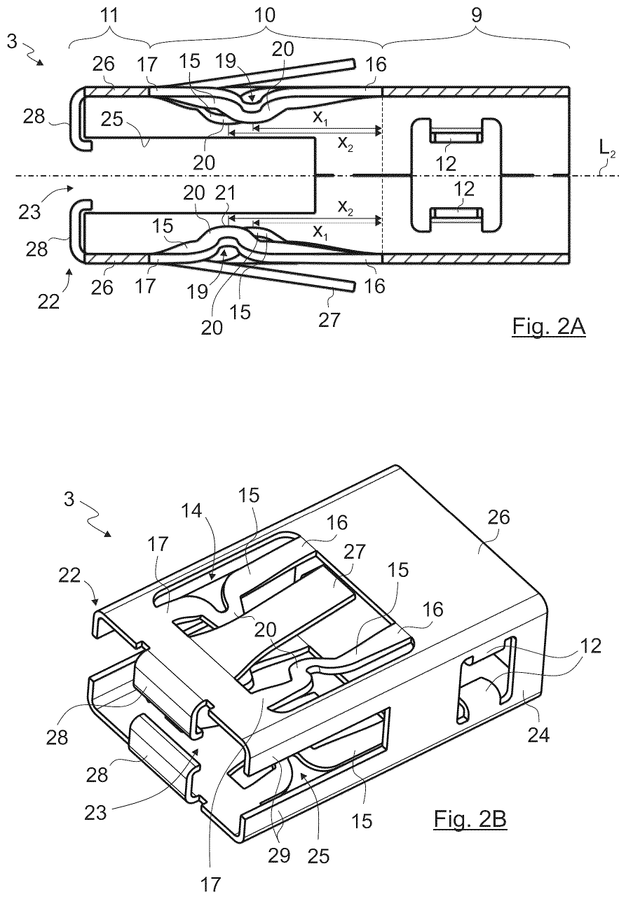

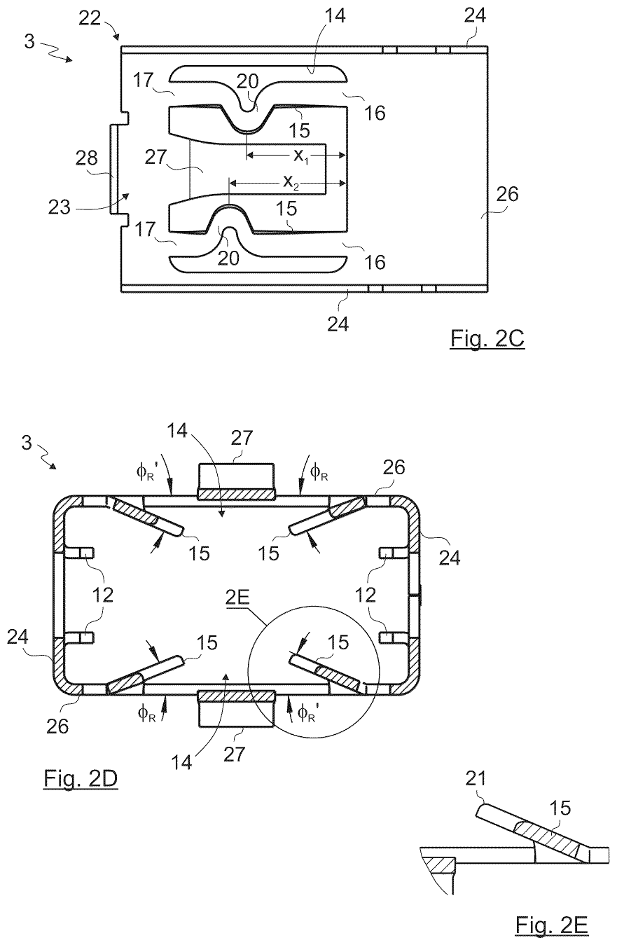

At least one rib 15 is arranged in an aperture 14 in the spring region 9, said rib contacting a respectively associated contact spring arm 8 in the plugged state of the contacting device 1, as illustrated, in particular, in FIG. 4. The number of ribs 15 of the cage 3 thus preferably corresponds to the number of contact spring arms 8 of the contact element 2. Each rib 15 is connected at its first axial end 16 to the fixing region 9 and at its second axial end 17 to the covering region 11. A longitudinal axis of each rib 15 extends parallel to the direction of the longitudinal axis L₂ of the cage 3. The individual rib 15 is in each case designed as a torsion rib, that is to say that, starting respectively from its first axial end 16 and its second axial end 17, each rib 15 is twisted relative to its longitudinal axis by a torsion angle ϕ_{R} (cf. FIG. 2D), in each case in the direction of an axial portion 19 situated between the first axial end 16 and the second axial end 17. Owing to the torsion of the rib 15, the individual rib 15 is prestressed in such a way that the spring force built up on account of the prestress in the rib 15 can exert a sufficient contact pressure on the associated contacting contact spring arm 8. It is only the torsion of the individual rib 15 that enables contacting between the rib 15 and the associated contact spring arm 8.

To improve the contacting of the contact spring arm 8 by the associated rib 15 a lateral portion 20 is formed on the rib 15 in the axial portion 19 of the rib 15 in the direction of the associated contact spring arm 8, said lateral portion also being referred to as a contact tongue and being designed either as a lateral extension or as a lateral offset of the rib 15. A contact point 21 of the rib 15 (cf. FIG. 4) is preferably formed in the region of the lateral portion 19 or contact tongue, said contact point providing the contact with the contact spring arm 8. It is also conceivable for a plurality of contact points 21 in the lateral portion 20 of the rib 15 to contact the associated contact spring arm 15.

The covering region 11 of the cage 3 covers the contact spring arms 8 of the contact element 1 in the axial and lateral directions in order as far as possible to prevent damage to the contact spring arms 8 from the outside. The contact spring arms 8 of the contact element 2 do not touch the covering region 11 of the cage 3 in the plugged state of the contacting device (cf. FIG. 4) in order to avoid restricting the spring travel of the individual contact spring arms 8.

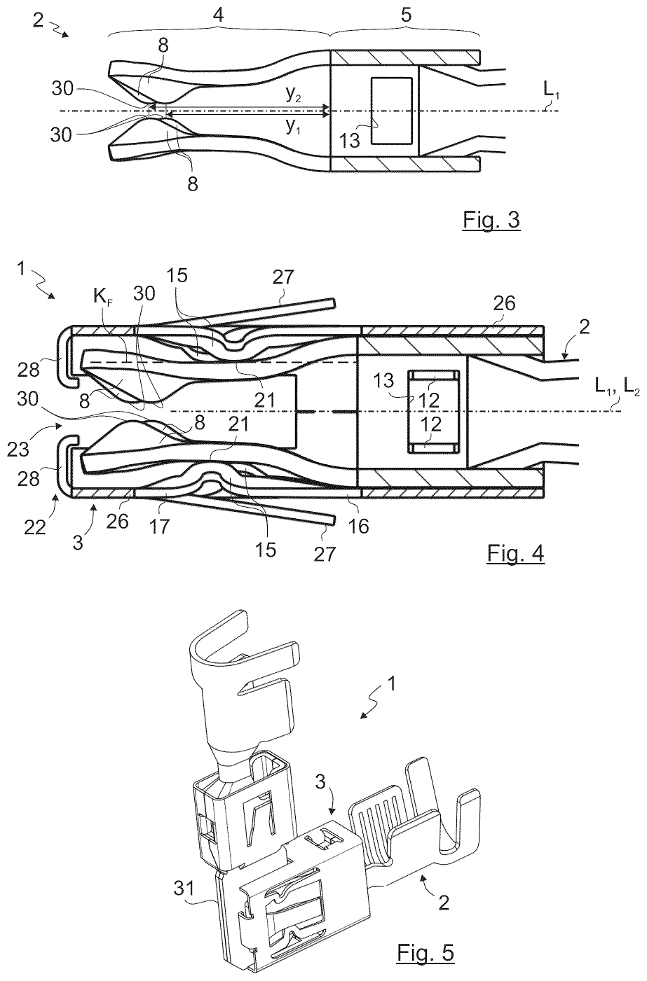

An axial plug-in opening 23 is formed in the cage 3 at the plug-in end 22 of the cage 3, and a mating contact element can be inserted axially into the contacting device 1 through this opening. Respective lateral plug-in openings 25 are formed in two opposite side walls 24 of the cage 3 in the region of the spring region 10 and of the covering region 11 of the cage 3, and a respective mating contact element can be inserted into the contacting device 1 through each of said openings in one of two possible lateral plug-in directions (cf. FIG. 5). The two opposite side walls 24 of the cage 3, in each of which a lateral plug-in opening 25 is formed, are oriented orthogonally to the side walls 26 of the cuboidally-shaped cage 3 in which the ribs 15 are formed. The axial plug-in opening 23 and the two lateral plug-in openings 25 preferably merge into one another, as is apparent especially from FIG. 1B.

To fasten the contacting device 1 in a plug connector housing, at least one fastening means 27, preferably two fastening means 27, is/are formed in the cage 3. The individual fastening means 27 is preferably implemented as a latching tab, which has a longitudinal extent in the direction of the longitudinal axis L₂ in order to enable as large a spring force as possible and as large a spring travel as possible. The individual latching tab is in each case formed parallel to the ribs 15 in an aperture 14 of the cage 3.

For axial protection of the individual contact spring arms 8 of the contact element 2, the axial plug-in opening 23 at the plug-in end 22 of the cage 3 is bounded by axial protection regions 28 of the cage 3, at the lateral end of which a catch funnel function is formed in the direction of the plug-in opening 23 (see FIG. 1A). In an equivalent way, each lateral plug-in opening 25 is bounded by two lateral protection regions 29 of the cage 3 in order to laterally protect the individual contact spring arms 8 of the contact element 2. A catch funnel function is likewise formed in the direction of the plug-in opening 25 at each of the lateral ends of the lateral protection regions 29 of the cage 3.

FIGS. 2A to 2E illustrate the cage 3 according to the invention for a flat contact element 2. FIG. 2A shows a longitudinal section, FIG. 2B shows an isometric illustration, FIG. 2C shows a lateral plan view, and FIG. 2D shows a cross section:

The contact points 21 in the twisted lateral portions 20 of ribs 15 which are formed on the same side wall 26 of the cage 3 are preferably formed in a manner axially offset from one another in the direction of the longitudinal axis L₂ of the cage, as is clearly apparent from FIG. 2A. As a particular preference, the contact points 21 in the twisted lateral portions 20 of diagonally opposite ribs 15 are each at an equal axial distance x₁ and x₂, respectively, from the fixing region 9 of the cage 3.

The twisting of the individual ribs 15 about their longitudinal axis is illustrated in the cross-sectional view of the cage 3 in FIG. 2D. From FIG. 2D, it can be seen that the torsion angle ϕ_{R} through which two diagonally opposite ribs 15 are rotated in each case is made slightly smaller than the torsion angle ϕ_{R}′ through which two further diagonally opposite ribs 15 are rotated in each case. The two first-mentioned ribs 15 thus have a lower spring stiffness than the two last-mentioned ribs 15, and each contact contact spring arms 8 with a higher spring stiffness than the two last-mentioned ribs 15. Thus, the overall stiffness for each pair of ribs 15 and contact spring arms 8 is the same in each case.

In the enlarged detail of a rib 15 in FIG. 2E, it can be seen that the contact point 21 of a rib 15 with the associated contact spring arm 8 is formed at a rounded edge of the rib 15.

FIG. 3 illustrates a detail of a contact element 2 according to the invention with the contacting region 4 and the axially adjoining fastening region 5. The contacting region 4 of the contact element 2 for contacting a flat mating contact element has two pairs of contact spring arms 8, each arranged opposite one another. The respective contact points 30 of contact spring arms 8 which contact the same contact surface of a flat mating contact element are each preferably at a different axial distance y₁ and y₂ from the fastening region 5 of the contact element 2 in the direction of the longitudinal axis L₁. As a particular preference, the contact points 30 of respective diagonally opposite contact spring arms 8 are at the same axial distance y₁ or y₂ from the fastening region 5.

FIG. 4 illustrates a contacting device 1 comprising a contact element 2 and the cage 3 in the plugged state. The contact point 21 of each rib 15 contacts a contact surface K_{F} (the dashed line in FIG. 4) of the associated contact spring arm 8. This contact surface K_{F} is shaped in such a way that, in the state of the contacting device 1 in which it is plugged together with the flat mating contact element, it is oriented parallel to the associated contact surface of the flat mating contact element.

FIG. 5 illustrates the contacting device 1 with a flat mating contact element 31 plugged in at the side.

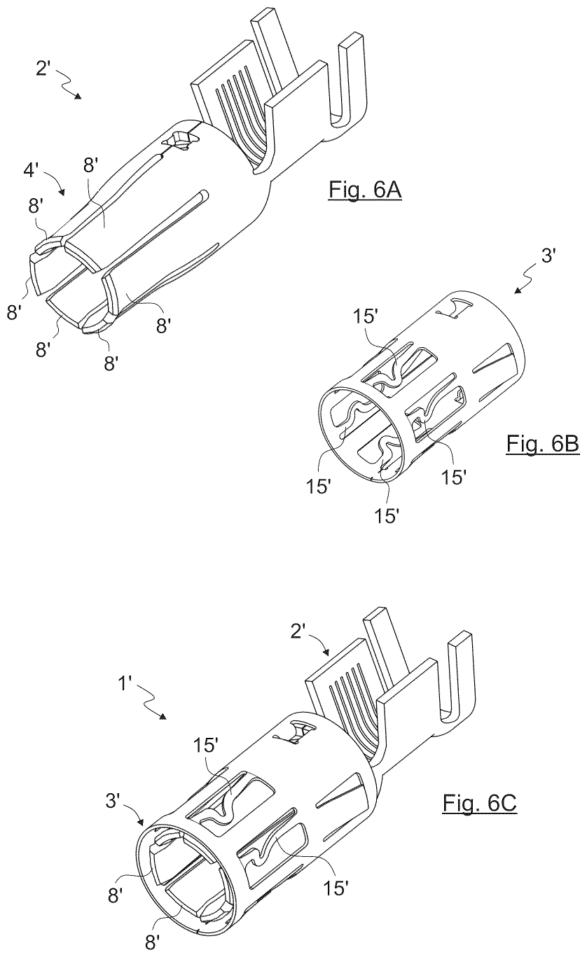

FIG. 6A illustrates a round contact element 2′, the contacting region 4′ of which has a plurality of contact spring arms 8′ arranged in the circumferential direction of the contact element 2′. An associated number of ribs 15′ is formed in the associated cage 3′ in FIG. 6B. Finally, FIG. 6C shows a contacting device 1′ with a round contact element 2′ and an associated cage 3′, the ribs 15′ of which are twisted in such a way that they contact the associated contact spring arms 8′ with a contact pressure.

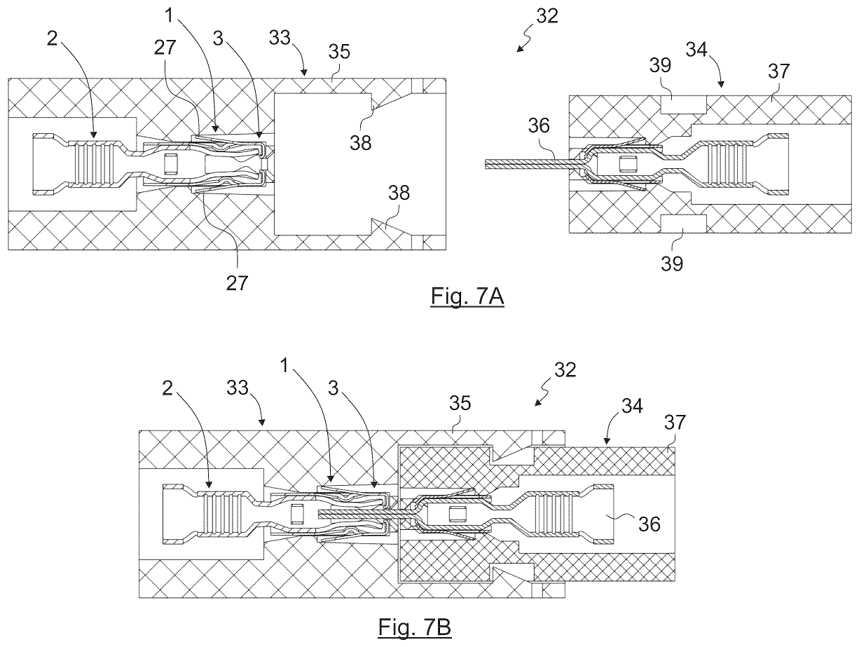

An electric plug connection 32 comprising an electric plug connector 33 and an associated electric mating plug connector 34 is illustrated in the unplugged state in FIG. 7A and in the plugged state in FIG. 7B. The electric plug connector 33 contains the contacting device 1 comprising a contact element 2, which is fastened in an associated cage 3, which is fastened in a plug connector housing 35 by means of two fastening means 27 designed as latching tabs. The electric mating plug connector 34 contains a mating contact element 36, which is designed as a flat contact element, which is likewise fastened in a mating plug connector housing 37 by means of fastening means designed as latching tabs. The plug connector housing 35 and the mating plug connector housing 37 can be fixed with respect to one another by means of a latching connection consisting of a latching hook 38 on the plug connector housing 35 and an associated latching recess 39 in the mating plug connector housing 37, for example.

Although the present invention has been fully described above with reference to preferred exemplary embodiments, it is not restricted thereto but can be modified in a variety of ways.

What is claimed is:

1. A cage for the reception of a contact element for an electric plug connector having a fixing region for fixing the cage on the contact element, a spring region, axially adjoining the fixing region, for contacting a contact spring arm of the contact element with a spring force, and a covering region, axially adjoining the spring region, for covering a plug-in end of the contact element, wherein an aperture is formed in the spring region, in which aperture there is arranged a rib, a first axial end of which is connected to the fixing region and a second axial end of which is connected to the covering region, wherein, starting from the first axial end and from the second axial end, the rib is in each case twisted through a torsion angle relative to a longitudinal axis of the rib in such a way that the contact spring arm is contactable by a contact point of the rib with the spring force.

2. The cage according to claim 1, wherein the contact point of the rib is formed in a lateral portion of the rib which forms a lateral extension or a lateral offset of the rib in a direction toward the contact spring arm.

3. The cage according to claim 1, wherein the rib has a rounded edge at the contact point.

4. The cage according to claim 1, wherein the torsion angle is between 10° and 50°.

5. The cage according to claim 4, wherein the torsion angle is between 18° and 30°.

6. The cage according to claim 5, wherien the torsion angle is between 21° and 24°.

7. The cage according to claim 1, wherein the cage has a rectangular cross-sectional profile, and at least one rib is formed on each of two opposite sides of the spring region.

8. The cage according to claim 7, wherein the at least one rib includes a pair of ribs each comprising two opposite ribs formed on each of the two opposite side of the spring region.

9. The cage according to claim 7, wherein the contact points of the pair of ribs formed on the same side of the spring region are each formed in a manner offset with respect to one another in an axial direction of the pair of ribs.

10. The cage according to claim 7, wherein the contact points on diagonally opposite ribs are each at the same axial distance from the fixing region.

11. The cage according to claim 7, wherein the torsion angle of the ribs, the contact point of which is in each case further away from the fixing region, is greater than the torsion angle of the ribs, the contact point of which is in each case axially closer to the fixing region.

12. The cage according to claim 1, wherein an axial plug-in opening is formed at a front end of the covering region.

13. The cage according to claim 1, wherein a lateral plug-in opening is formed in at least one lateral end of the spring region.

14. The cage according to claim 13, wherien the lateral plug-in opening is formed in each of the two lateral ends of the spring region.

15. A contacting device for contacting a mating contact element of an electric mating plug connector having a contact element and a cage according to claim 1, through which the contact element at least partly extends, wherein the contact element has a fastening region, which is connected to the fixing region of the cage, and a contacting region, which axially adjoins the fastening region, wherein the contacting region has at least one contact spring arm, which is in each case connected to the fastening region, wherein the at least one contact spring arm is in each case configured to contact the mating contact element, wherein the contact point of the respective rib in each case contacts the associated contact spring arm with the spring force.

16. The contacting device according to claim 15, wherein the contact point of the respective rib contacts a contact surface of the associated contact spring arm, which is shaped in such a way that, when contact is made between the contact spring arm and a contacting surface of the mating contact element, the contact surface is oriented parallel to the contacting surface.

17. The contacting device according to claim 16, wherein the contact element has two pairs, each comprising two opposite contact spring arms, wherein contact points of the contact spring arms which are configured to contact the same contact surface of the mating contact element are formed in a manner offset with respect to one another in an axial direction of the contact spring arms.

18. The contacting device according to claim 17, wherein the contact points of diagonally opposite contact spring arms which are configured to contact the mating contact element are each formed at the same axial distance from the fastening region.

19. An electric plug connector having a contacting device according to claim 15 and a plug connector housing, through which the contacting device at least partly extends and to which the contacting device is connected.
